(19) United States
(12) Patent Application Publication
(10) Pub. No.: US 2012/0026292 A1
(43) Pub. Date: Feb. 2, 2012

(54) MONITOR COMPUTER AND METHOD FOR MONITORING A SPECIFIED SCENE USING THE SAME

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/094,752

(22) Filed: Apr. 26, 2011

(30) Foreign Application Priority Data
Jul. 27, 2010 (TW) 99124751

(51) Int. Cl. H04N 13/02

(52) U.S. Cl. 348/46; 348/E13.074

(57) ABSTRACT

A method for monitoring a specified scene obtains a scene image of the specified scene captured by an image capturing device, determines a first sub-area of the scene image, detects a three dimensional (3D) figure area in the scene image, and controls movement of the lens of the image capturing device according to movement data of the 3D figure area if the 3D figure area has been detected. The method further detects a position of the 3D figure area, and sends warning messages to a specified electronic device if the 3D figure area is in the first sub-area of the scene image.

### BACKGROUND

1. Technical Field

Embodiments of the present disclosure relate to surveillance technology, and particularly to a monitor computer and method for monitoring a specified scene using the monitor computer.

2. Description of Related Art

Video cameras with pan/tilt/zoom (PTZ) functions have been popularly adopted in surveillance systems. A PTZ video camera is able to focus on a specified scene at a distance with a wide angle range and capture an amplified image of the specified scene. The PTZ camera can be remotely controlled to track and record any activity in the specified scene. However, real time observation of monitor displays is required to detect anomalous activity. If PTZ functions are not implemented in a timely manner, captured images may not be clear and recognizable. Therefore, an efficient monitor computer and method for monitoring the specified scene is desired.

### BRIEF DESCRIPTION OF THE DRAWINGS

FIG. 1 is a schematic diagram of one embodiment of a monitor computer.

FIG. 2 is a block diagram of one embodiment of a security monitor system.

FIG. 3 is a flowchart of one embodiment of a method for monitoring a specified scene using the monitor computer.

FIG. 4 and FIG. 5 show examples of a captured three dimensional (3D) image using the image capturing device of FIG. 1.

FIG. 6 shows an example of a first sub-area of a scene image, captured by the image capturing device of FIG. 1.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

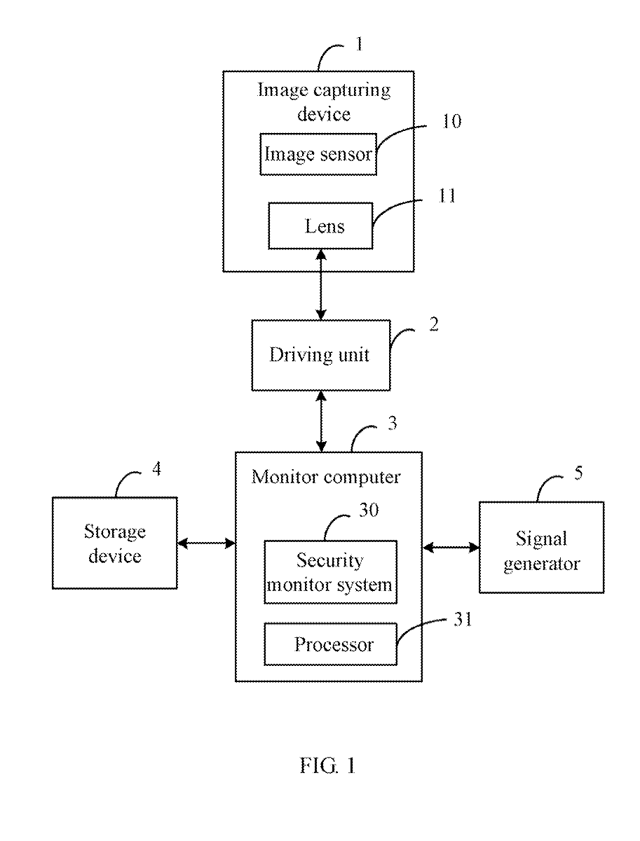

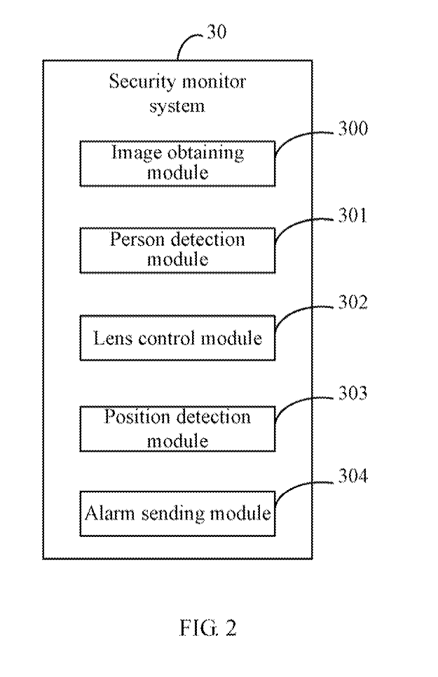

FIG. 1 is a schematic diagram of one embodiment of a monitor computer 3. In one embodiment, the monitor computer 3 is connected to an image capturing device 2 through a driving unit 2, and further connected to a storage device 4 and a signal generator 5. The image capturing device 1 includes an image sensor 10 and a lens 11. The image sensor 10 senses images of a specified scene via the lens 11. The monitor computer 3 includes a security monitor system 30 and at least one processor 31. The security monitor system 30 may be used to obtain a scene image, captured by the image capturing device 1, detect a person in the scene image, and send warning messages to a specified electronic device through the signal generator 5. A detailed description will be given in the following paragraphs.

In one embodiment, the image capturing device 1 may be a speed dome camera or pan/tilt/zoom (PTZ) camera, for example. The monitored scene may be the roof of a building or other important places. It is understood that, in this embodiment, the image capturing device 1 is a camera system that captures a distance from a target object to the lens 11 (distant information) using the time-of-flight (TOF) principle, which can obtain a distance between the lens 11 and each point on the target object to be captured, so that each image captured by the image capturing device 1 includes distance information between the lens 11 and each point on the object in the image. The driving unit 2 includes a pan (P) motor, a tilt (T) motor, and a zoom (Z) motor for driving x-axis movement, y-axis movement of the lens 11, and adjusting a focus of the lens 11 respectively.

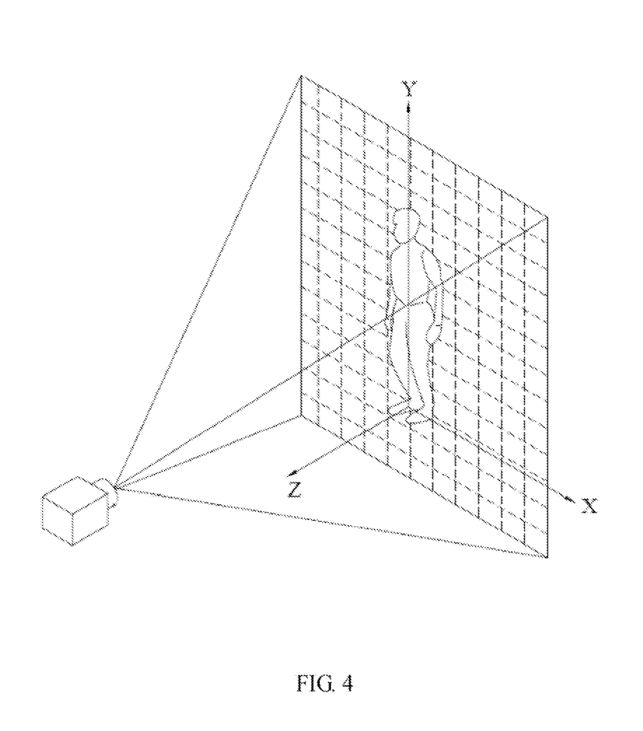

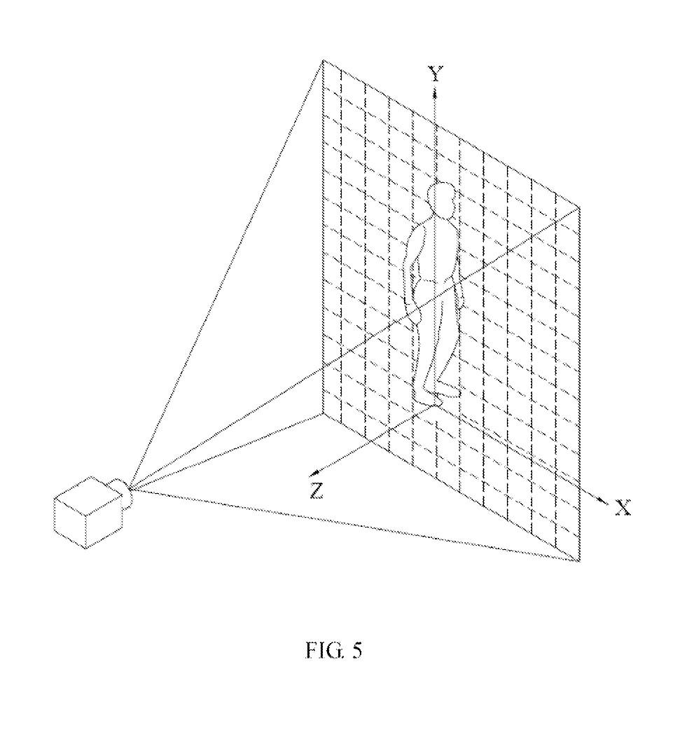

In one embodiment, the storage device 4 stores three dimensional (3D) figure images and 3D figure templates. The 3D figure images are captured by the image capturing device 1. In one embodiment, the 3D figure images may include frontal images (as shown in FIG. 4) and side images (as shown in FIG. 5), for example. A frontal image of a person is an image captured when the image capturing device 1 is positioned in front of the person, and a side image of the person is an image captured when the image capturing device 1 is positioned at one side of the person. Depending on the embodiment, the storage device 4 may be a smart media card, a secure digital card, or a compact flash card.

In one embodiment, the security monitor system 30 may include one or more modules, for example, an image obtaining module 300, a person detection module 301, a lens control module 302, a position detection module 303, and an alarm sending module 304. The one or more modules 300-304 may include computerized code in the form of one or more programs that are stored in the storage device 4 (or memory). The computerized code includes instructions that are executed by the at least one processor 31 to provide functions for the one or more modules 300-304.

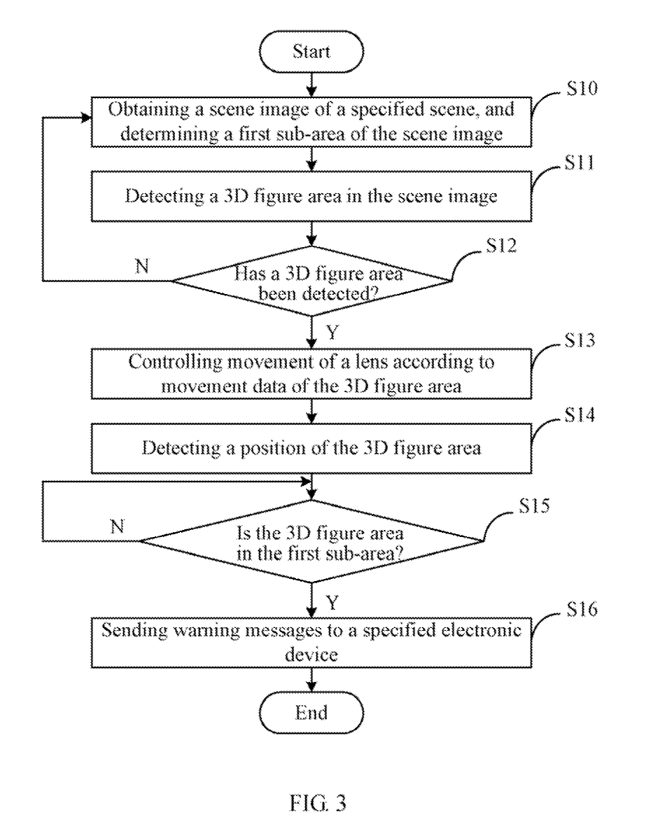

FIG. 3 is a flowchart of one embodiment of a method for monitoring a specified scene using the monitor computer 3. Depending on the embodiment, additional blocks may be added, others removed, and the ordering of the blocks may be changed.

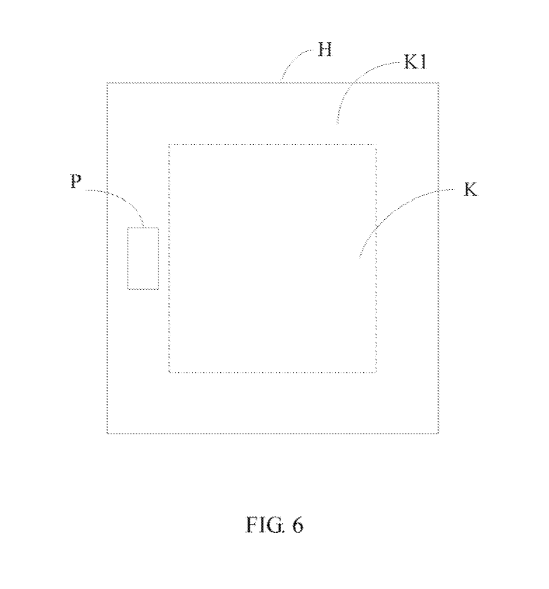

In block S10, the image obtaining module 300 obtains a scene image of the specified scene captured by the lens 11 of the image capturing device 1, and determines a first sub-area of the scene image. In one embodiment, as shown in FIG. 6, “H” represents a first rectangle of the scene image of the specified scene, “K” represents a second rectangle in the first rectangle “H”, “P” represents a person, and “K1” represents the first sub-area of the scene image between the first rectangle “H” and the second rectangle “K”. In some embodiments, the first sub-area “K1” of the specified scene is regarded as a dangerous place. If the person “P” comes into the first sub-area of the scene image “K1,” the security monitor system 30 sends warning messages to a specified electronic device (e.g., a mobile phone).

In block S11, the person detection module 301 detects a 3D figure area in the scene image. In one embodiment, the 3D figure area is regarded as a person in the specified scene. A detailed description is provided as follows.

First, the person detection module 301 converts a distance between the lens 11 and each point of the specified scene in the scene image to a pixel value of the point, and creates a character matrix of the scene image. Second, the person detection module 301 compares a pixel value of each point in the character matrix with a pixel value of a corresponding character point in a 3D figure template. Third, the person detection module 301 determines if a second sub-area has a first specified number (e.g., n1) of points existing in the scene image, to determine if the scene image has a 3D figure area. A pixel value of each point in the second sub-area is within an allowance range of a corresponding character point in the 3D figure template, where the second sub-area is regarded as a 3D figure area in the scene image.

For example, a pixel value of the nose in the character matrix is compared with the pixel value of the nose in the 3D figure template. The 3D figure template may store a number Q1 of character points, and the first specified number may be set as Q1*80%. If the second sub-area exists in the scene image, the person detection module 301 determines that the second sub-area is a 3D figure area.

In block S12, the person detection module 301 determines if the 3D figure area has been detected in the scene image. If the 3D figure area has been detected in the scene image, the procedure goes to block S13. If the 3D figure area has not been detected in the scene image, the procedure returns to block S10.

In block S13, the lens control module 302 controls movement of the lens 11 of the image capturing device 1 using the driving unit 2 according to movement data of the 3D figure area, to capture clear scene image of the specified scene. In detail, the lens control module 302 sends a first control command to pan and/or tilt the lens 11 of the image capturing device 1 until a center of the 3D figure area superposes on a center of the scene image. The lens control module 302 sends a second control command to zoom in the lens 11 of the image capturing device 1 until an area ratio of the 3D figure area to the scene image equals a preset proportion (e.g., 45%). Based on the movement and the adjustment of the lens 11, the image capturing device 1 captures a 3D figure image, and stores the 3D figure image into the storage device 4. It is understood that, in this embodiment, if the area ratio of the 3D figure area to the scene image equals the preset proportion, the scene image is regarded as the 3D figure image that is clear.

In one embodiment, the movement data of the 3D figure area may include, but is not limited to, a direction of the movement and a distance of the movement. For example, the lens control module 302 determines that the lens 11 should move towards the left if the direction of movement in the 3D figure area is left, or determines that the lens 11 should be moved towards the right if the direction of movement in the 3D figure area is right.

In block S14, the position detection module 303 detects a position of the 3D figure area. In one embodiment, the position of the 3D figure area includes coordinates of each point of the 3D figure area in a coordinate system based on the specified scene.

In block S15, the position detection module 303 determines if the 3D figure area is in the first sub-area of the scene image. If the 3D figure area has a second specified number of points existing in the first sub-area of the scene image, the position detection module 303 determines that the 3D figure area is in the first sub-area of the scene image, the procedure goes to block S16. If the 3D figure area does not have the second specified number of points existing in the first sub-area of the scene image, the position detection module 303 determines that the 3D figure area is not in the first sub-area of the scene image, the procedure returns to block S14. Supposing the 3D figure area may store a number Q2 of character points, and the second specified number may be set as Q2*50%.

In block S16, the alarm sending module 304 generates warning messages using the signal generator 5, and sends the warning messages to the specified electronic device (e.g., the mobile phone). In one embodiment, the warning messages may include a position of the specified scene and the scene image of the specified scene.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for monitoring a specified scene using a monitor computer, the method comprising:
obtaining a scene image of the specified scene, and determining a first sub-area of the scene image, the scene image captured by a lens of an image capturing device connected to the monitor computer through a driving unit;
detecting a three dimensional (3D) figure area in the scene image;
controlling movement of the lens of the image capturing device through the driving unit according to movement data of the 3D figure area upon the condition that the 3D figure area has been detected;
detecting a position of the 3D figure area, and determining if the 3D figure area is in the first sub-area of the scene image; and
sending warning messages to a specified electronic device upon the condition that the 3D figure area is in the first sub-area of the scene image.

2. The method according to claim 1, wherein the step of detecting a 3D figure area in the scene image comprises:
converting a distance between the lens and each point of the specified scene in the scene image to a pixel value of the point, and creating a character matrix of the scene image;
comparing a pixel value of each point in the character matrix with a pixel value of a corresponding character point in a 3D figure template; and
determining that the scene image has a 3D figure area upon the condition that a second sub-area has a first specified number of points existing in the scene image, wherein a pixel value of each point in the second sub-area is within an allowance range of a corresponding character point in the 3D figure template, the second sub-area is regarded as the 3D figure area in the scene image.

3. The method according to claim 1, wherein the step of controlling movement of the lens of the image capturing device through the driving unit according to movement data of the 3D figure area comprises:
sending a first control command to pan and/or tilt the lens of the image capturing device until a center of the 3D figure area superposes on a center of the scene image; and
sending a second control command to zoom in the lens of the image capturing device until an area ratio of the 3D figure area to the scene image equals a preset proportion.

4. The method according to claim 1, wherein the step of determining if the 3D figure area is in the first sub-area of the scene image comprises:
determining that the 3D figure area is in the first sub-area of the scene image upon the condition that the 3D figure area has a second specified number of points existing in the first sub-area of the scene image; and
determining that the 3D figure area is not in the first sub-area of the scene image upon the condition that the 3D figure area does not have the second specified number of points existing in the first sub-area of the scene image.

5. A monitor computer, comprising:
a storage device;
at least one processor; and
one or more modules that are stored in the storage device and are executed by the at least one processor, the one or more modules comprising instructions:
to obtain a scene image of the specified scene, and determine a first sub-area of the scene image, the scene image captured by a lens of an image capturing device connected to the monitor computer through a driving unit;
to detect a three dimensional (3D) figure area in the scene image;
to control movement of the lens of the image capturing device through the driving unit according to movement data of the 3D figure area upon the condition that the 3D figure area has been detected;
to detect a position of the 3D figure area, and determine if the 3D figure area is in the first sub-area of the scene image; and
to send warning messages to a specified electronic device upon the condition that the 3D figure area is in the first sub-area of the scene image.

6. The monitor computer according to claim 5, wherein the instruction to detect a 3D figure area in the scene image comprises:
converting a distance between the lens and each point of the specified scene in the scene image to a pixel value of the point, and creating a character matrix of the scene image;
comparing a pixel value of each point in the character matrix with a pixel value of a corresponding character point in a 3D figure template; and
determining that the scene image has a 3D figure area upon the condition that a second sub-area has a first specified number of points existing in the scene image, wherein a pixel value of each point in the second sub-area is within an allowance range of a corresponding character point in the 3D figure template, the second sub-area is regarded as the 3D figure area in the scene image.

7. The monitor computer according to claim 5, wherein the instruction to control movement of the lens of the image capturing device through the driving unit according to movement data of the 3D figure area comprises:
sending a first control command to pan and/or tilt the lens of the image capturing device until a center of the 3D figure area superposes on a center of the scene image; and
sending a second control command to zoom in the lens of the image capturing device until an area ratio of the 3D figure area to the scene image equals a preset proportion.

8. The monitor computer according to claim 5, wherein the instruction to determine if the 3D figure area is in the first sub-area of the scene image comprises:
determining that the 3D figure area is in the first sub-area of the scene image upon the condition that the 3D figure area has a second specified number of points existing in the first sub-area of the scene image; and
determining that the 3D figure area is not in the first sub-area of the scene image upon the condition that the 3D figure area does not have the second specified number of points existing in the first sub-area of the scene image.

9. A non-transitory storage medium having stored thereon instructions that, when executed by a processor of a monitor computer, causes the processor to perform a method for monitoring a specified scene, the method comprising:
obtaining a scene image of the specified scene, and determining a first sub-area of the scene image, the scene image captured by a lens of an image capturing device connected to the monitor computer through a driving unit;
detecting a three dimensional (3D) figure area in the scene image;
controlling movement of the lens of the image capturing device through the driving unit according to movement data of the 3D figure area upon the condition that the 3D figure area has been detected;
detecting a position of the 3D figure area, and determining if the 3D figure area is in the first sub-area of the scene image; and
sending warning messages to a specified electronic device upon the condition that the 3D figure area is in the first sub-area of the scene image.

10. The non-transitory storage medium according to claim 9, wherein the step of detecting a 3D figure area in the scene image comprises:
converting a distance between the lens and each point of the specified scene in the scene image to a pixel value of the point, and creating a character matrix of the scene image;
comparing a pixel value of each point in the character matrix with a pixel value of a corresponding character point in a 3D figure template; and
determining that the scene image has a 3D figure area upon the condition that a second sub-area has a first specified number of points existing in the scene image, wherein a pixel value of each point in the second sub-area is within an allowance range of a corresponding character point in the 3D figure template, the second sub-area is regarded as the 3D figure area in the scene image.

11. The non-transitory storage medium according to claim 9, wherein the step of controlling movement of the lens of the image capturing device through the driving unit according to movement data of the 3D figure area comprises:
sending a first control command to pan and/or tilt the lens of the image capturing device until a center of the 3D figure area superposes on a center of the scene image; and
sending a second control command to zoom in the lens of the image capturing device until an area ratio of the 3D figure area to the scene image equals a preset proportion.

12. The non-transitory storage medium according to claim 9, wherein the step of determining if the 3D figure area is in the first sub-area of the scene image comprises:
determining that the 3D figure area is in the first sub-area of the scene image upon the condition that the 3D figure area has a second specified number of points existing in the first sub-area of the scene image; and
determining that the 3D figure area is not in the first sub-area of the scene image upon the condition that the 3D figure area does not have the second specified number of points existing in the first sub-area of the scene image.

13. The non-transitory storage medium according to claim 11, wherein the medium is selected from the group consisting of a hard disk drive, a compact disc, a digital video disc, and a tape drive.
